(19) United States
(12) Patent Application Publication
(10) Pub. No.: US 2008/0089989 A1
(43) Pub. Date: Apr. 17, 2008

(54) Apparatus with flow divider and method for making multicolored cereal

(75) Inventors: Robert Chatel, Hoffman Estates, IL (US); Marcus Parsons, Crystal Lake, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Quaker Oats Company, Inc., Chicago, IL (US)

(21) Appl. No.: 11/546,873

(22) Filed: Oct. 11, 2006

(51) Int. Cl. A23L 1/00

(52) U.S. Cl. 426/516

(57) ABSTRACT

A method and device for producing a multicolored food piece includes providing a flow stream of a first food mass that has a first color. The first flow stream of the first food mass is injected with a second food mass that has color that is different in color, or in hue, than the first food mass. Thereafter the food mass flow stream is divided into a plurality of sub-streams and is extruded through a die port.

### FIELD OF THE INVENTION

The present invention relates to food processing devices and methods. More particularly, the present invention relates to such devices and methods for producing multicolored cereal pieces.

### BACKGROUND OF THE INVENTION

A need exists for a method and device for producing multicolored food pieces, such as cereal or snack food pieces. It would be advantageous for such method and device to form the cereal pieces from a flowing first food mass that has a second food mass, of a different color or hue, added into the first food mass to form a third food mass that is directly expanded to form a food piece.

A need also exists for a method and food processing device that forms a multicolored food piece from a first flowing food mass with a distinct pattern formed by a second food mass, of different color or hue from a first food mass, that has been injected in the first flowing food mass and is extruded from the device to produce a puffed food piece that maintains at least a portion of the distinct pattern contained in the combined flowing food mass.

### SUMMARY OF THE INVENTION

In accordance with one aspect of the invention a method of making a multi-colored cereal is provided that includes providing a flow stream of a first food mass of a first color and then injecting a second food mass, that has a second color differing from the first color, in color or in hue, into the flow stream of the first food mass. Thereafter, the flow stream is split into a plurality of sub-streams and then the sub-streams are extruded through a die port and subsequently divided into discrete food or cereal pieces.

In accordance with another aspect of the invention, an apparatus for producing a food product from a flowable extrudate is provided and has a housing that has a first passageway having an inlet and an outlet. The inlet is adapted for receiving into the first passageway a first flowable food mass having a first color. The apparatus includes a fluid additive injector positioned in operative relationship with the first passageway for injecting a second food mass, of a different color or hue than the first color, into the first food mass to form a third food mass having a distinct pattern of the second food mass therein. The apparatus has a plurality of sub-passageways downstream of the first passageway with each of the plurality of sub-passageways having an inlet and an outlet. The sub-passageways receive the flowing third food mass to thereby split the third food mass flow into the plurality of downstream sub-passageways to form a plurality of sub-streams. The sub-streams of the flowing third food mass have at least a portion of the distinct pattern of the second food mass maintained in the sub-streams. A die port associated with said each of said sub-passageways is provided to extrude the sub-streams through the die port.

In accordance with another aspect of the invention, a die plate for extruding food products from a food mass flowing through the die plate is provided and has a body with a front surface, a rear surface and a sidewall between the front and rear surfaces. The die plate has a generally cone shaped surface formed therein with the cone including a front tip and a rearward end. The rear end of the cone is spaced a first distance from the rear surface of the die plate and the tip of the cone is positioned a second distance from the rear surface of the die plate. The second distance is greater than the first distance. The die plate has a generally annular shaped passageway that has an outlet, and has an inlet thereto on the front surface of the die plate. The annular passageway is defined by an inner surface corresponding to the cone shaped surface and also defined by an outer surface that is formed in the body of the die plate and is spaced from the cone surface. The inner surface extends outwardly towards the sidewall from the inlet of the annular passage to the outlet of the annular passageway. The outer surface defining the annular passageway also extends outwardly towards the sidewall from the inlet of the annular passageway to the outlet of the intermediate passageway. The die plate has a plurality of downstream sub-passageways each having an inlet and an outlet, the inlets of the sub-passageways being positioned adjacent the outlet of the annular passageway to provide fluid communication between the annular passageway and the plurality of sub-passageways. The sub-passageways provide for a splitting of the food mass flowing through the annular passageway into a plurality of sub-streams of flowing food mass. The sub-passageways have a convergent portion positioned between the sub-passageway inlet and the sub-passageway outlet for converging a sub-stream of food mass flowing there through. The die plate has a plurality of die ports in fluid communication with the sub-passageways for extruding a food mass through the die port.

### BRIEF DESCRIPTION OF THE DRAWINGS

FIG. 1 is a schematic drawing showing the food processing device and method of the invention;

FIG. 2 is a front plan view showing the inlet hole pattern of the die plate of the food processing device;

FIG. 3 is a front plan view showing the outlet hole pattern of the die plate of the food processing device.

FIG. 4 is a schematic view of the stripe detail of the injector of the food processing device;

### DETAILED DESCRIPTION OF THE INVENTION

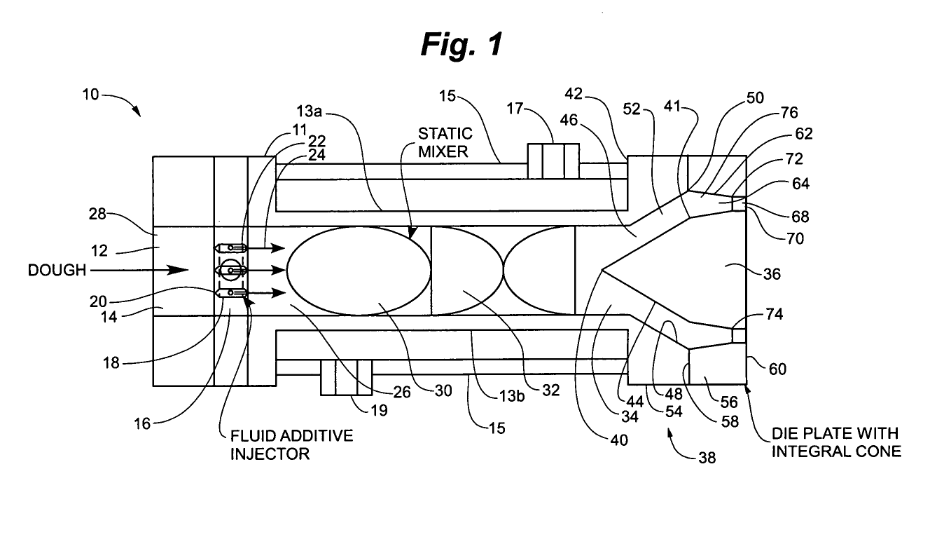

FIG. 1 illustrates a schematic diagram of a food processing device 10 for producing multicolored food products, such as, for example, cereal pieces, in accordance with the present invention. Device 10 is ideally suited for processing a cooked food cereal dough or first food mass 12, that is typical of a relatively viscous fluid. Food mass 12 is processed by device 10 to form a ready-to-eat cereal, food snack or other such product. Upstream of device 10 is an extruder cooker (not shown) of standard construction known in the art. The extruder cooker produces viscous cooked cereal dough or other food product 12 that is fed into passageway 14 formed in the housing 11 of food processing device 10. Food mass 12 passes through passageway 14 to a fluid additive injector 16, that may be of the construction and operation as disclosed in U.S. Pat. No. 6,509,049, the entire disclosure of which is incorporated by reference herein.

Injector 16 is axially aligned within passageway 14 and has ribs 18, each with a leading edge 20 positioned on the upstream side of injector 16. Flowing food mass 12 first contacts ribs 18 of injector 16 at leading edge 20 of ribs 18, causing food mass 12 to pass around ribs 18. As first food mass 12 passes the downstream side 22 of ribs 18, injector 16 injects a second food mass 24 into the flow stream of first food mass 12. The injected second food mass 24 may be comprised of a food colorant that is of a color that is different in color or in hue than the color of first dough food mass 12 upstream of injector 16. Second food mass 24 need not be limited to a food colorant. Food mass 24 may include a flavor additive, food supplement, any other desired food additive, or a food dough different in color or in hue than the color of first food mass 12.

As depicted in FIGS. 1 and 3, injector 16 adds second food mass 24 within first food mass 12 to form a third flowing food mass 26 downstream of injector 16. Third flowing food mass 26 is essentially the same as first food mass 12 except for the inclusion of a pattern of three distinct lines, or planes, or regions comprised of injected second food mass 24. Alternatively, and if desired, other patterns for second food mass 24 may be formed within the third food mass 26 by modification of the configuration of injector 16, such as to produce a different number of lines or to produce a different pattern. A series of injectors 16 may also be utilized to form more complex patterns of second food mass 24 within third food mass 26.

Food processing device 10 may also optionally include a static mixer assembly 30 positioned in passageway 14 downstream of injector 16. Static mixer assembly 30 is composed of an elongated tubular structure and includes mixer flights 32 as is known in the art. Tubular structure 13a, 13b is jacketed 15 to permit heating or cooling as desired with an appropriate fluid. Inlet 17 and outlet 19 may be provided for fluid flow to permit such heating or cooling. A sufficient number of mixer flights 32 are provided to achieve the desired degree of mixing for a particular product. Static mixer 30 may not be designed with mixer flights 32 that are of a number or configuration that would aggressively mix food mass 26 so as to make unrecognizable the distinct pattern of lines, or planes of second food mass 24 that are interspersed within first food mass 12. Preferably, mixer flights 32 are optionally provided to gently mix food mass 26 without significantly disrupting the border between first food mass 12 and second food mass 24 to an extent that a distinct and detailed pattern of second food mass 24 is no longer present.

Food mass 26, with its distinct pattern intact, continues downstream in passageway 14 to reach cone 36 adjacent the outlet 34 of passageway 14. Cone 36 is integrally formed with a die plate 38 and is positioned with the front tip 40 of cone 36 axially aligned within tubular passageway 14. As shown in FIG. 1, the base 41 of cone 36 is located within die plate 38 and front tip 40 extends into passage 14 forward of the front face 42 of die plate 38. Alternately, cone tip 40 may be positioned along the plane of front face 42, or positioned rearward of front face 42.

As food mass 26 flows past cone tip 40, it is directed by the surface 44 of cone 36 into annular passageway 46 of die plate 38. Annular passageway 46 is defined on one side by cone surface 44, and on the other side by a surface 48 formed in die plate 38. Surface 48 may be generally parallel to cone surface 44 as shown in FIG. 1, but may also, for example, be formed to be divergent relative to cone surface 44. It is noted that passageway 46 is preferably configured so that passageway 46 has a cross sectional area at its rear or outlet end 50 that is approximately the same, or greater, than cross sectional area of passageway 14 taken along a plane intersecting front tip 40 of cone 36. The cross sectional area of passageway 46 at its rear end 50 is also the same, or greater than the cross sectional area of annular passageway 46 taken along the plane of front face 42 at the inlet end 52 of passageway 46.

It is noted that for ease of cleaning, the body of die plate 38 may be formed of two or more sections, such as an upstream or front section 54 and a downstream or rear section 56 that includes integrally formed cone 36. Front section 54 and rear section 56 are reversibly secured together by any suitable means, such as by bolts (not shown).

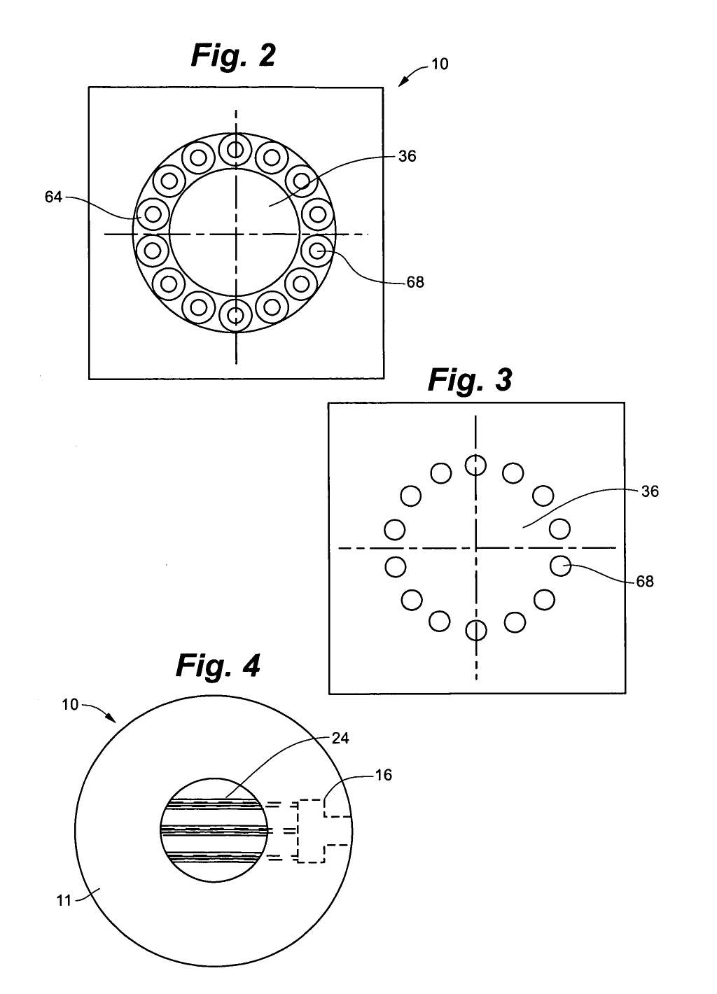

Referring to FIG. 1, FIG. 2 and FIG. 3, rear section 56 of die plate 38 includes a front side 58 and a rear or exit side 60. Rear section 56 also includes a plurality of tapered bores 62 forming a plurality of tapered passageways or converging portions 64 extending rearwardly from front side 58 of rear section 56. Tapered passageways 64 may extend to exit side 60 of rear section 56, but preferably extend only to an intermediate location between front side 58 and exit side 60 of rear section 56. Preferably, rear section 56 includes bores 62 in rear side 60 forming a plurality of final passageways 68 that provide fluid communication between tapered passageways 64 and an exit port 70 at the end of each of final passageways 68. Final passageways 68 may be fitted with die inserts (not shown) that have a cross sectional shape designed to produce a food piece of a corresponding cross sectional shape, such as oval, octagonal, or other novel shape.

Thus, the pathway of the movement of a food mass through food processing device 10 includes entering into passageway 14 at its inlet 28, flowing past fluid injector 16, passage through optional static mixer 30, and continued flowing past cone tip 40 of die plate 38. As food mass 26 flows into annular passageway 46, the shape of food mass 26 is reformed from a circular cross section into an annular cross section. Thereafter, the flow of food mass 26 continues through annular passageway 46 and is divided, or split, into a plurality of sub-streams 76 flowing in a plurality of sub-passageways comprising converging passageways 64. Each of passageways 64 has an outlet 72 adjacent to, and in fluid communication with, an inlet 74 providing entrance into each of final passageways 68. The plurality of sub-streams 76 of food mass 26 exit device 10 at an exit port 70 provided for each of passageways 68. Adjacent exit port 70, a cutter blade (not shown) is provided to cut the exiting extruded food mass into pieces of a desired length. The cutter blade may be of any of the designs known in the art, such as a blade positioned to rotate parallel rear side 60 of die plate 38. The cutter blades may rotate at a speed timed to cut the extrudate into desired length pieces adjacent exit ports 70. As the food pieces encounter ambient temperature and pressure conditions, the food pieces are directly expanded, or puffed, and may rapidly increase in size to form the final food product, such as multicolored cereal food pieces.

In order to ensure maintaining the fine detail of the lines, or other pattern that second food mass 24 provides within food mass 26, device 10 may have additional design considerations. The taper of converging portion 64 may be formed such that it provides a reduction of about 3.5 to 1, or less in the cross sectional area of the flowing third food mass 26 from the point of entrance of passageway 64, as compared to the cross sectional area of food mass 26 as it leaves passageway 64. The cross sectional area reduction may be about 3.5 to 1, or less, along any segment of the pathway of food mass 26 within device 10, including, for example, a segment having its upstream end at cone tip 40 and its downstream end at the plurality of exit ports 70. It is noted that for purposes of comparing the cross sectional area of flow mass 26 that has been split into a plurality of sub-streams 76 to the cross sectional area of food mass 26 prior to splitting, the sum of the cross sectional areas of all sub-streams 76 may be compared to the cross sectional area of flow mass 26 prior to splitting to determine the ratio of the reduction in cross sectional area. Of course, it is to be understood that the reductions in cross sectional areas referred to above need not be limited to 3.5 to 1 or less. The reduction may be, for example, greater than 2.0 to 1 or greater than 3.5 to 1, if desired.

In an alternative embodiment, (not shown) multiple die plates 38 may be utilized to further manipulate sub-streams 76 prior to direct expansion. For example, a second die plate 38 may be positioned adjacent each exit port 70 of an upstream first die plate 38. In such an arrangement, sub-streams 76 of a circular cross sectional shape leave first die plate 38 and are once again reformed into an annular flow stream by annular passageway 46 of second die plate 38, and then are further divided into multiple sub-streams 76 prior to direct expansion upon exiting die ports 70 of the second die plate 38. Hence the second die plates 38 may be identical in configuration and shape to that of the first die plate, except that the second die plates 38 may be reduced in size. In this sense, the upstream die plate 38 can act as a flow dividing passageway without allowing direct expansion at exit ports 70. The final downstream die plate 38 both divides sub-streams 76, and also allows direct expansion at exit ports 70.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

Modifications may be made to the embodiments described above without departing from the broad inventive concepts thereof. Accordingly, the present invention is not limited to the particular embodiments nor to the theoretical description disclosed, but is intended to cover all modifications that are within the spirit and scope of the invention as defined in the appended claims. Moreover, the embodiments described herein are meant to be merely illustrative and not restrictive.

What is claimed is:

1. A method of making a multicolored cereal piece comprising: providing a flow stream of a first food mass of a first color; injecting a second food mass having a second color differing from said first color, in color or in hue, into said flow stream of said first food mass; thereafter dividing said flow stream into a plurality of sub-streams; and thereafter extruding said sub-streams through a die port.

2. The method of claim 1 wherein each sub-stream has a portion of said first food mass and said second food mass.

3. The method of claim 1 further comprises reducing the cross sectional area of each of the sub-streams by at least a factor of 2.

4. The method of claim 1 wherein said flow stream has a first cross sectional shape and is reformed into a flow stream having a second cross sectional shape that is different from said first cross sectional shape of said flow stream, and thereafter dividing said flow stream into said plurality of sub-streams.

5. The method of claim 4 wherein said first different cross sectional shape is generally circular and said second cross sectional shape is generally annular.

6. The method of claim 4 wherein said first circular cross sectional shape has a first area and said second cross sectional shape has a second area, and said first area being approximately the same as or less than said second area.

7. The method of claim 1 wherein at least some of said sub-streams are divided at least a second time prior to said extruding through said die port.

8. The method of claim 1 wherein said injecting of said second food mass into said first food mass forms a third food mass having a distinct pattern provided by said second food mass, and at least a portion of said distinct pattern remains as a distinct pattern in said third food mass after said dividing and after said extruding of said sub-streams.

9. The method of claim 7 where each of said sub-streams is reduced in cross sectional area by a factor of about 3.5 or more prior to said extruding through said die port.

10. The method of claim 5 wherein said flow stream is passed over a cone-shaped member to reform said flow stream into said annular shape, and thereafter passing said annular flow stream into a plurality of sub-passageways to divide said flow stream into said plurality of sub-streams.

11. The method of claim 10 wherein each of said sub-streams is converged in said sub-passageways prior to extruding through said die port, said passageways reducing said cross sectional area of said sub-streams by a ratio of no more than 3.5 to 1.

12. The method of claim 11 further comprising passing said food through a static mixer after said injecting said second food mass and prior to said dividing into a plurality of sub-streams.

13. An apparatus for producing a food product from a flowable extrudate comprising:
a housing;
a first passageway within said housing, said first passageway having an inlet and an outlet, said inlet receiving a first flowable food mass having a first color into said first passageway;
a fluid additive injector for injecting a second food mass, of a different color or hue than said first color, into said first food mass, said injector positioned in operative relationship with said first passageway and injecting said second food mass into said first flowing food mass as it flows through said first passageway to form a third food mass having a distinct pattern of said second food mass therein;
a plurality of sub-passageways downstream of said first passageway, each of said plurality of sub-passageways having an inlet and an outlet, said sub-passageway inlets in fluid communication with said first passageway and receiving a portion of said flowing third food mass to thereby divide said flowing third food mass into a plurality of sub-streams of said flowing third food mass with at least a portion of said distinct pattern of said second food mass maintained in said sub-streams; and
a die port adjacent at least one of said sub-passageway outlets to extrude said sub-stream through said die port.

14. The apparatus of claim 13 wherein each of said sub-passageways has at least a portion therein that is a converging portion that converges said flowing third food mass to provide a reduction in cross sectional area of said third food mass as it flows through said converging portion, said reduction of said cross sectional area being less than or equal to 3.5 to 1.

15. The apparatus of claim 14 wherein said apparatus includes at least one intermediate passageway between said first passageway and said plurality of sub-passageways, said intermediate passageway having an inlet and an outlet, said intermediate passageway inlet in fluid communication with said outlet of said first passageway for receiving said third food mass, and said intermediate passageway outlet in fluid communication with said inlets of said plurality of said sub-passageways, said first passageway having a first cross sectional shape and a first cross sectional area, said intermediate passageway having a second cross sectional shape and second cross sectional area, said second cross sectional shape being different than said first cross sectional shape, and said second cross sectional area being at least as great or greater than said first cross sectional area.

16. The apparatus of claim 15 wherein said intermediate passageway has an outer peripheral surface extending from said intermediate passageway inlet to said intermediate passageway outlet, said outer peripheral surface of said intermediate passageway at said intermediate passageway outlet positioned outwardly from said outer peripheral surface of said intermediate passageway at said intermediate passageway inlet.

17. The apparatus of claim 16 where first shape of said first passageway is generally circular and said second shape of said intermediate passageway is annular.

18. The apparatus of claim 17 wherein said apparatus has a die plate that includes at least a portion of said intermediate passageway and at least a portion of said sub-passageways, said die plate including a generally cone-shaped surface having a front tip and a rear, said front tip positioned upstream from said rear of said cone, said intermediate passageway defined by an inner surface and a outer peripheral surface, said cone-shaped surface providing said inner surface of said intermediate passageway, and a surface formed in said die plate that is spaced from said cone-shaped surface providing said outer peripheral surface of said intermediate passageway.

19. The apparatus of claim 13 wherein each of said sub-passageways has at least a portion therein that is a converging portion that converges said flowing third food mass to provide a reduction in cross sectional area of said third food mass as it flows through said converging portion, said reduction of said cross sectional area being greater than 3.5 to 1.

20. A die plate for extruding food products from a food mass flowing through said die plate comprising:
a body, said body having a front surface, a rear surface and a sidewall between said front and rear surfaces; said die plate having a general cone-shaped surface formed therein, said cone including a front tip and a rear end, said rear end of said cone being spaced a first distance from said rear surface of said die plate, and said tip of said cone being spaced a second distance from said rear surface of said die plate, said second distance being greater than said first distance;
said die plate having a generally annular shaped passageway having an inlet thereto on said front surface of said die plate and having an outlet, said annular passageway having an inner surface defined by said cone-shaped surface and a outer surface formed in said die plate and spaced from said cone-shaped surface, said inner surface extending outwardly towards said sidewall from said inlet of said intermediate passage to said outlet of said intermediate passageway, said outer surface defining said intermediate passageway also extending outwardly towards said sidewall from said inlet of said annular passageway to said outlet of said intermediate passageway;
said die plate having a plurality of sub-passageways each having an inlet and an outlet, said inlets of said sub-passageways positioned adjacent said outlet of said annular passageway to provide fluid communication between said annular passageway and said plurality of sub-passageways, said sub-passageways for dividing said food mass flowing through said annular passageway into a plurality of sub-streams of flowing food mass; and
said sub-passageways having a convergent portion positioned between said sub-passageway inlet and said sub-passageway outlet for converging a food mass flowing therethrough.

21. The die plate of claim 20 wherein said front tip of said cone extends outwardly from said front surface of said die body.

22. The die plate of claim 21 wherein said annular passageway has a cross sectional area at said annular passageway outlet that is at least as great as said cross sectional area at said inlet opening at said front surface of said die plate, and said convergent portion of said sub-passageway reduces said cross sectional area of said passageway by no greater than a ratio 3.5 to 1.
